(19) United States
(12) Patent Application Publication
(10) Pub. No.: US 2015/0180381 A1
(43) Pub. Date: Jun. 25, 2015

(54) CONTROL SYSTEM FOR AND A METHOD OF CONTROLLING A SUPERCONDUCTIVE ROTATING ELECTRICAL MACHINE

(71) Applicant: Danmarks Tekniske Universitet, Lyngby (DK)

(72) Inventors: Nenad Mijatovic, Bagsvard (DK); Bogi Bech Jensen, Skovlunde (DK)

(21) Appl. No.: 14/409,170

(22) PCT Filed: Jul. 2, 2013
(86) PCT No.: PCT/DK2013/050219

§ 371 Date: Dec. 18, 2014

(30) Foreign Application Priority Data
Jul. 2, 2012 (EP) 12174572.3

(51) Int. Cl. H02P 6/00

(52) U.S. Cl. CPC H02P 6/002

(57) ABSTRACT

This invention relates to a method of controlling and a control system (100) for a superconductive rotating electric machine (200) comprising at least one superconductive winding (102; 103), where the control system (100) is adapted to control a power unit (101) supplying during use the at least one superconductive winding (102; 103) with power or receiving during use power from the at least one superconductive winding (102; 103), wherein the control system (100) is further adapted to, for at least one superconductive winding (102; 103), dynamically receive one or more representations of one or more actual values (110, 111) of one or more parameters for a given superconductive winding (102; 103), each parameter representing a physical condition of the given superconductive winding (102; 103), and to dynamically derive one or more electrical current values to be maintained in the given superconductive winding (102; 103) by the power unit (101) where the one or more electrical current values is/are derived taking into account the received one or more actual values (110, 111). In this way, greater flexibility and more precise control of the performance of the superconducting rotating electrical machines is obtained since control is enabled that takes into account an actual or current state of the superconductive winding(s).

### FIELD OF THE INVENTION

The present invention relates to a control system for and a method of controlling a superconductive rotating electric machine comprising at least one superconductive winding.

### BACKGROUND OF THE INVENTION

Superconducting rotating electrical machines are becoming an increasingly important part of further advancements in a number of different technical fields and industries. As examples of areas that could benefit greatly from improvements of power density and/or increased efficiency that superconducting rotating electrical machines can offer are e.g. areas of ship propulsion units, wind turbines, large utility turbo generators, electric aircrafts and vehicles, etc. or in general any type of area where electrical machines with high power density or high efficiency could be of use.

A trend towards large scale wind turbines has, as an example, driven the cost of energy down, and there is an incentive for continuing this trend.

However, conventional machines are not readily able to deliver the power density necessary for a continued scale up of wind turbine size. Superconducting rotating electrical machines can typically have power densities of at least twice as high as conventional machines (e.g. based on a permanent magnet, induction, switched reluctance, and other types of machines), which make such superconducting rotating electrical machines excellent for future wind turbines having power ratings above e.g. 10 megawatt (MW).

Superconducting rotating electrical machines typically comprise at least one superconducting coil cooled to operating temperatures for that specific superconducting rotating electrical machine. The load of the superconducting coil(s) depends on operating temperature, strength of the magnetic field, and in the case of so-called high temperature superconductors (HTS) also the orientation of the magnetic field with respect to the superconductor coil(s).

A basis for operation of all types of rotating electrical machines (including superconducting rotating electrical machines) is the interaction of two or more magnetic fields, typically one arising from one or more stationary windings (e.g. multiphase winding(s) typically called armature winding(s) in the context of synchronous electrical machines) and one arising from one or more revolving windings (typically called field winding(s) in the context of synchronous electrical machines).

Superconductive materials (e.g. MgB₂, BiSCCO, YBCO, NbTi, NbSn₃) have transport current characteristics that to a larger or smaller degree are dependent on the intensity and orientation of the magnetic field at the superconductive coil. Therefore, when at least one of the windings is superconductive, the presence of a magnetic field from the other winding(s) will affect the superconducting winding by changing the magnetic conditions.

A presence of an additional magnetic field at the superconductive coil will decrease the current capacity and could cause an increase of temperature, which could be critical if not handled appropriately. In a worst case the temperature increase could potentially cause a thermal runaway.

Since rotating electrical machinery—including superconducting rotating electrical machines—fundamentally is based on interaction between at least two magnetic fields, then the designer must, when applying superconducting technology in electrical machines e.g. like generators or motors, identify the maximal magnetic field that the superconducting rotating electrical machine is expected be exposed to and set the operational conditions of the superconductive winding(s) accordingly.

Therefore, in order to avoid potentially catastrophic failures of such superconductive rotating electrical machines (e.g. thermal runaway of the superconductive winding(s) often referred to as quench), e.g. by temperature increasing too much, the operating conditions are typically kept on the safe or even very safe side of a situation or state designed to accommodate full or even faults loads of the superconductive rotating electrical machine. Thus, maximum operating temperature, magnetic field from both the superconductive and non-superconductive windings and the electrical current of the superconductive winding(s) will define the maximal electrical current capacity that the superconductive winding(s) can sustain in all cases. However, the electrical current of the superconductive winding(s) chosen in this way will result in a superconductive rotating electrical machine with constant or lower field (excitation), which in turn causes lower efficiency at partial loads.

Thus, there is a need for a simple and efficient way of improving efficiency at partial loads in superconductive rotating electrical machines and to do so in a safe manner.

Patent specification U.S. Pat. No. 8,076,894 discloses a superconductive rotating electric machine drive control system where a control operation is performed so that the field current applied to the superconductive field winding of a synchronous rotating electric machine satisfies an equation for the field current in accordance with the variation of the electric power exchanged between the synchronous rotating electric machine and the power unit.

### OBJECT AND SUMMARY OF THE INVENTION

It is an object to provide a control system for a superconductive rotating electric machine and a method of controlling or operating a superconductive rotating electric machine that enables or has improved efficiency at partial loads.

Additionally, an objective is to enable maximal utilisation of one or more superconductive windings.

A further object is to enable greater flexibility and more precise control of the performance of the superconducting rotating electrical machine.

Yet another object is to provide this in a safe manner.

According to one aspect, one or more of these objects are achieved at least to an extent by a control system for a superconductive rotating electric machine comprising at least one superconductive winding, where the control system is adapted to control a power supply or power unit (forth only denoted power unit) supplying during use the at least one superconductive winding with power or receiving during use power from the at least one superconductive winding, wherein the control system is further adapted to, for at least one superconductive winding, dynamically receive one or more representations of one or more actual values of one or more parameters for a given superconductive winding, each parameter representing a physical condition of the given superconductive winding, and to dynamically derive one or more electrical current values to be maintained in the given superconductive winding by the power unit where the one or more electrical current values is/are derived taking into account the received one or more actual values.

The power unit may then apply the derived one or more electrical current values in the given superconductive winding.

In this way, greater flexibility and more precise control of the performance of the superconducting rotating electrical machines is obtained since control is enabled that takes into account an actual or current state of the superconductive winding(s).

In one embodiment, the superconducting rotating electrical machine is a synchronous machine.

In one embodiment, the control system is adapted to derive the one or more electrical current values as being maximal within a predetermined safety margin for the superconducting rotating electric machine or the at least one superconductive winding while still ensuring that the superconducting rotating electric machine or the at least one superconductive winding is superconductive.

In this way, the control system will control the electrical current(s) supplied to the superconducting winding(s) to be as maximal as possible while still being superconducting within a certain safety margin. This—compared to a static boundary or limit of supplied electrical current taking worst case conditions into considerations (i.e. full load and maximum predicted operating temperature and magnetic field) provides much better efficiency at partial loads, i.e. away from the worst case condition, and also at more favorable operating magnetic fields.

In one embodiment, the one or more representations of one or more actual values of one or more parameters comprises
a current value of an operating temperature of a given superconductive winding,
at least one current value of an electric current of the given superconductive winding, and
at least one current value of a magnetic field of the given superconductive winding.

In one embodiment, the current value of the magnetic field of a given superconductive winding is obtained or estimated according to any one of:
using one or more magnetic sensors directly or indirectly measuring or estimating the magnetic field of the at least one superconductive winding,
applying a park transformation on one or more received currents and voltages providing two values, one being proportional to an armature flux of the superconducting rotating electrical machine of the same orientation as a flux generated by the given (superconductive) field winding and one being proportional to a torque of the superconducting rotating electrical machine and estimating the magnetic field from two provided values using an electro-magnetic model of the superconducting rotating electrical machine, or
obtaining the voltage of the given superconductive winding and estimating the magnetic field using the obtained voltage and the current value of an operating temperature and a critical electrical current of the given superconductive winding.

In one embodiment, the at least one superconductive winding comprises a superconductive rotating winding and/or a superconductive stationary winding.

In one embodiment, the superconductive rotating winding is a superconductive field winding and/or the superconductive stationary winding is a superconductive armature winding.

In one embodiment, the at least one superconductive winding comprises a superconductive field winding (if it is supplied with DC currents) and it can be stationary or rotating.

In one embodiment, the at least one superconductive winding comprises a superconductive armature winding (if it operates with AC currents and voltages) and can also be rotating or stationary. In general, if the field winding is rotating then armature is stationary and vice versa.

In DC electrical machines, the armature is rotating and the field winding is stationary.

According to another aspect, the invention also relates to a method of controlling a superconductive rotating electric machine comprising at least one superconductive winding, where the method controls a power unit supplying during use the at least one superconductive winding with power or receiving during use power from the at least one superconductive winding, wherein the method, for at least one superconductive winding, dynamically receives one or more representations of one or more actual values of parameters for a given superconductive winding, each parameter representing a physical condition of the given superconductive winding, and dynamically derives at least one electrical current value to be maintained in the given superconductive winding by the power unit where the electrical current value is derived taking into account the received one or more actual values.

The method and embodiments thereof correspond to the control system and embodiments thereof and have the same advantages for the same reasons.

Another aspect relates to a superconductive rotating electrical machine comprising at least one superconductive winding, a power unit supplying during use the at least one superconductive winding with power or receiving during use power from the at least one superconductive winding, and a control system according to any one of claims 1-6

A further aspect relates to a use of the control system according to any one of claims 1-6 or of the method of controlling according to any one of claims 7-12 in a superconductive rotating electric machine.

For the various embodiments of the control system, the use thereof, and the method of controlling a superconductive rotating electric machine as described throughout this specification and variations thereof, it is to be understood that various suitable refresh or timing schemes for the dynamic reception and the dynamic derivation may be implemented as fitting to a given use or situation.

As an example, the refresh rate of dynamically receiving the one or more representations of one or more actual values of parameters for the given superconductive winding may e.g. be at the same rate as typically used in conventional current control for generators, e.g. at a rate measured in hundreds of microseconds up to few milliseconds.

Furthermore, as an example, the refresh rate of dynamically deriving the at least one electrical current value to be maintained (and applying it) in the given superconductive winding by the power unit may e.g. be at the same rate as above or potentially even a bit slower, e.g. at a rate measured in hundreds of milliseconds or even at a few seconds.

### BRIEF DESCRIPTION OF THE DRAWINGS

These and other aspects will be apparent from and elucidated with reference to the illustrative embodiments as shown in the drawings, in which:

FIG. 1 schematically illustrates one embodiment of a control system for a superconductive rotating electrical machine;

FIG. 2 schematically illustrates one embodiment of the control scheme compared to the traditional situation;

FIG. 3 schematically illustrates one embodiment of obtaining and deriving control parameters used in one embodiment of the control scheme of the present invention;

FIG. 4 schematically illustrates an example of superconducting properties for a given superconductive winding; and

FIGS. 5a and 5b schematically illustrate examples of synchronous superconducting rotating electrical machines with one pair and multiple (e.g. two) pairs of poles that could use the control scheme according to the various embodiments of the present invention.

### DESCRIPTION OF PREFERRED EMBODIMENTS

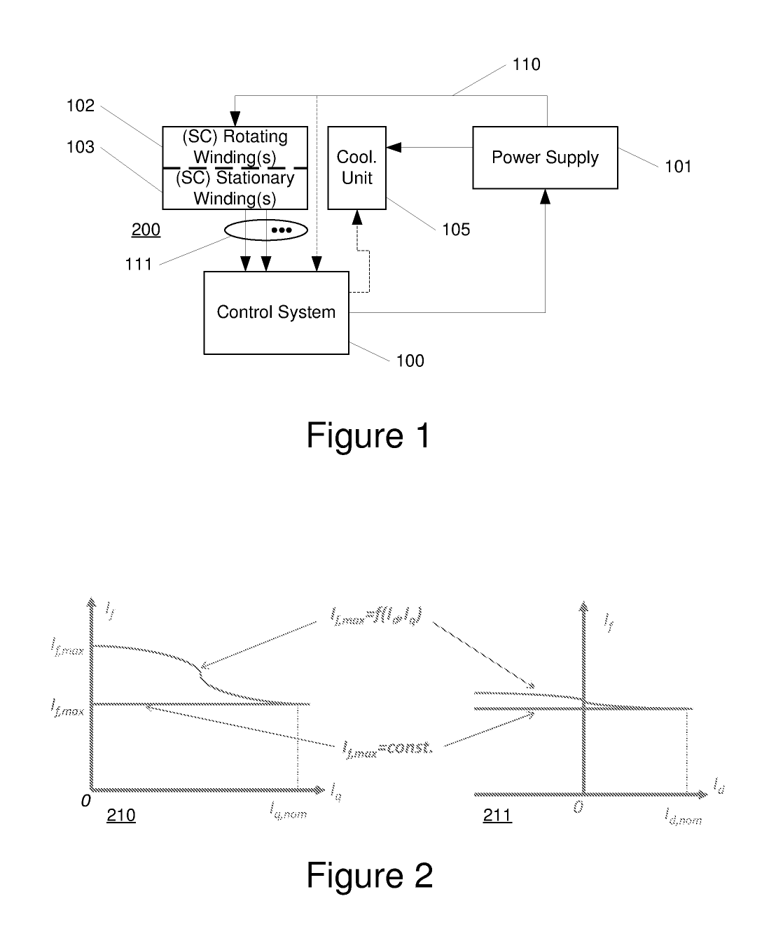

FIG. 1 schematically illustrates one embodiment of a control system for a superconductive rotating electrical machine. Shown is the control system 100 dynamically receiving one or more inputs or representations 111, 110 as will be explained in more detail in the following.

The control system 100 is connected to a power unit 101 that supplies (when the superconducting rotary electrical machines is a motor) or receives (when the superconducting rotary electrical machine is a generator) power to or from a superconductive rotating electrical machine 200. In the following, the elements are described as the superconducting electrical machine is or is working as a motor but the invention is equally applicable for generators. The power unit 101 optionally also supplies power to a cooling unit 105, responsible for cooling the superconductive rotating electrical machine 200 to appropriate operating temperatures. Alternatively, the cooling unit 105 may be powered by a different source.

The superconductive rotating electrical machine 200 comprises at least one rotating winding 102 comprising one or more coils and at least one but commonly two, three or more stationary windings 103 comprising one or more coils where at least one of the windings 102 or 103 is/are superconductive windings.

In embodiments throughout the description, the stationary winding(s) 103 may comprises armature winding(s) or field winding(s) while the rotating winding(s) 102 may comprise field winding(s) or armature winding(s), respectively.

The control system 100 is adapted to dynamically control the power unit 101 and more specifically is adapted to dynamically control which specific electrical current(s) 110 the power unit 100 dynamically is/are supplying to the coil(s) of the superconductive winding(s) 102, 103.

If the superconductive rotating electrical machine 200 only comprises one superconductive winding, only the current(s) supplied to that may be controlled. If the superconductive rotating electrical machine 200 comprises two or more superconductive windings, only the current(s) supplied to one of the superconductive windings, e.g. the rotating one(s), may be controlled. Alternatively, the current(s) supplied to all the superconductive windings may be controlled.

As mentioned, the control system 100 dynamically receives one or more representations of one or more actual values 110, 111 of one or more parameters that represent a physical condition of the at least one superconductive winding 102, 103, i.e. at least a part of an actual or current state for the superconductive winding(s).

If only one of the windings is superconducting, the representation of values may e.g. comprise a current (as in present or actual, forth only referred to as current) value of an operating temperature 111 of the superconductive winding 102, 103, at least one current value of an electric current 110 of the superconductive winding 102, 103, and at least one current value of a magnetic field 111 of the superconductive winding 102, 103.

The magnetic field 111 may e.g. be the maximal magnetic field.

If one superconducting winding comprises a plurality of superconducting coils, there e.g. would be one electrical current value for each superconductive coil and e.g. one magnetic field value also for each superconductive coil. Normally, all coils would be operated at the same temperature, so normally there is no need for additional temperature values but in principle there could be.

If two (or more) of the windings are superconducting, all of these values may be obtained separately for each.

The current temperature value may readily be obtained (or estimated with high or sufficient precision) e.g. by standard temperature measurement sensors usually or often already present in such superconducting rotary electrical machines monitoring the actual temperature. In any event, they are fairly easy to include when designing a superconducting rotary electrical machine and are necessary to achieve reliable and precise temperature control by the cooling unit 105.

The current electrical current value(s) 110 may readily be obtained e.g. directly from the output of the power unit 101. Alternatively, electrical current sensors that often are integrated into the power unit 101 or converter may readily provide these. In case the superconducting rotary electrical machine is working as a generator, electrical current or power is transferred to the power unit 101 and the current electrical current value(s) needs to be obtained by measurement or estimation from the rotating and/or stationary windings. 102, 103.

The current magnetic field value may be obtained e.g. by using one or more magnetic sensors directly or indirectly measuring or estimating the magnetic field of the superconductive winding(s) 102, 103. The magnetic sensor(s) may e.g. comprise a Hall element or other e.g. integrated into the superconductive winding(s).

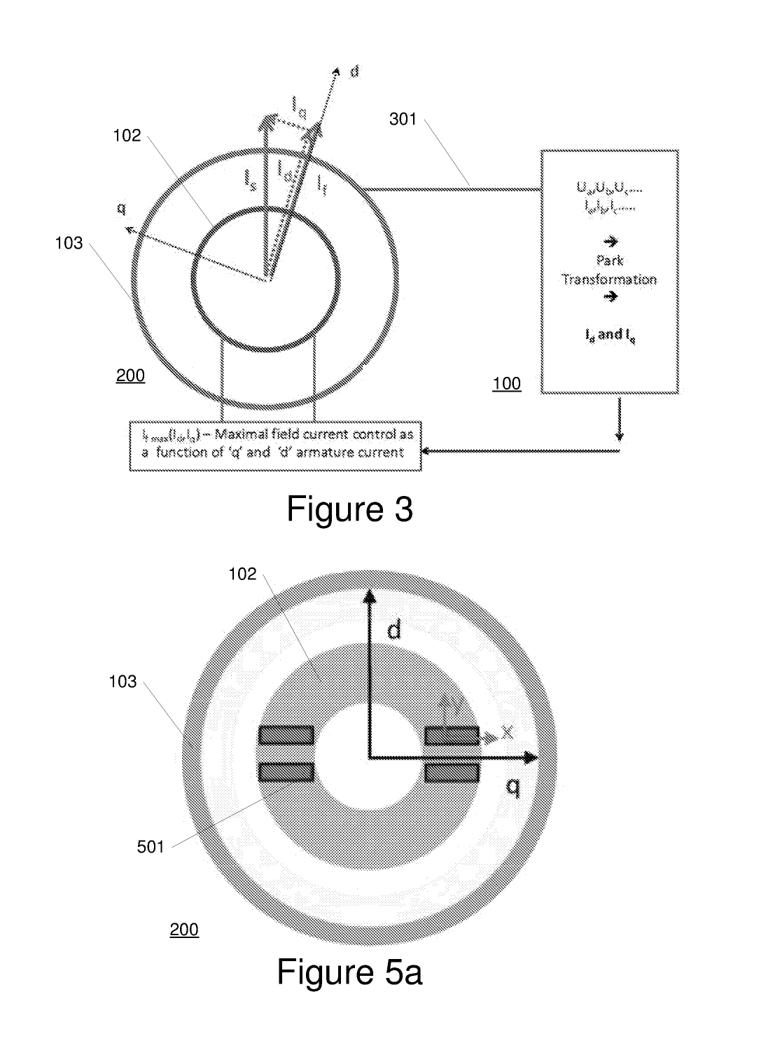

Alternatively, the current magnetic field value may be obtained e.g. by measuring or estimating the electrical currents and voltages of the rotating and/or stationary winding(s), as shown and explained for one example in greater detail in connection with FIG. 3, and then applying an appropriate mathematical transformation, e.g. the Park transformation, direct-quadrature-zero components also referred to as zero-direct-quadrature or the like on the measured or estimated values of the electrical currents and voltages to derive representative (simpler or fewer) values. The direct-quadrature-zero is sometimes also denoted dq0 or dqo and the zero-direct-quadrature is sometimes also denoted 0dq or odq.

In the case of Park transformation, the two currents I_{q} and I_{d} (please see FIG. 3) are derived from the measured or estimated electrical currents and voltages of the rotating and/or stationary armature winding(s). According to well-known machine theory, it is possible to achieve so called decoupling of two axes, where I_{q} would be proportional to the torque of the rotating electrical machine (including superconducting) while I_{d} would be proportional to the armature flux in the machine responsible for induced voltage and being of the same orientation as the flux from the field winding(s).

The magnetic flux (and thereby the magnetic field) may then be estimated from the transformed values using an electro-magnetic model of the superconducting rotating electrical machine. The electro-magnetic model of a (superconducting rotating) electrical machine would commonly include a system of a number of mutual and leakage inductances and/or magnetic reluctances and/or permeances for all three axes, d, q and 0. These inductances can be evaluated in the design/testing-construction phase and can allow for the estimation of magnetic flux conditions in the whole machine. Estimates of flux, based on this model, can e.g. be further advanced by detailed numerical study and/or experimental verification.

As yet another alternative, the magnetic field value may be estimated by measuring or estimating the voltage of the one or more superconductive windings since the voltage follows the power law expressed as:

$$E = {{E}_{0} ( \frac{{I}_{sc}}{{I}_{c} ( B , T )} )}^{n}$$

where I_{c}(B,T) is a critical electrical current of the given superconductive winding being a function of the magnetic field and temperature, I_{sc} is the current(s) of the given superconductive winding, E₀ is a constant being equal to 10⁻⁴ V/m, and n is the transition coefficient. From this expression—knowing the voltage and the temperature—an estimate of the magnetic field can be derived.

Critical current of a superconductor is a transport current trough a superconductor at specific operating conditions (such as temperature of superconductor, magnetic field intensity and orientation, mechanical pressure and other parameters) at which the voltage drop caused by the current flow is most commonly taken to be equal to E₀=0.1 mV/m per unit length of a superconductor, but it may also take other values, e.g. E₀=0.01 mV/m. Critical current of a superconductor in general is a function of magnetic field and temperature.

It is to be noted, that other ways of deriving or estimating the magnetic field or the other values may be equally applicable.

Furthermore, additional representations of additional values representing other physical conditions may be used and supplied to the control system 100.

Based on the dynamically received one or more representations of one or more actual values 110, 111 of parameters that represent at least a part of an actual or current state of the superconductive winding(s), the control system 100 dynamically derives an electrical current to be supplied to each of the at least one superconducting winding(s) 102,103 by the power unit 101 taking into account the received one or more representations.

In this way, greater flexibility and more precise control of the performance of the superconducting rotating electrical machines is obtained since control is enabled that takes into account an actual or current state of the superconductive winding(s).

In one embodiment, the control system 100 is adapted to derive, for each superconducting winding or at least one of them, the electrical current value that is maximal by a predetermined safety margin for the superconducting rotating electric machine 200 or the at least one superconductive winding (102; 103) while still ensuring that the superconducting rotating electric machine (200) or the at least one superconductive winding (102; 103) is superconductive, and taking into account the actual state (i.e. temperature, magnetic field, and current electrical current of the superconductive winding).

In this way, the control system 100 will control the electrical current(s) supplied to the superconducting winding(s) to be as maximal as possible while still being superconducting within a certain safety margin. This—compared to a static boundary or limit of supplied electrical current taking worst case conditions into considerations (i.e. full load and maximum predicted operating temperature and magnetic field) provides much better efficiency at partial loads, i.e. away from the worst case condition, and also at more favorable operating magnetic fields. This is e.g. illustrated according to one embodiment in FIG. 2.

The inventors have successfully achieved a reduction of up to 20% of the energy loss compared to a static boundary or limit of supplied electrical current at a partial load of 50%. Furthermore, the inventors have been able to increase the electrical current to a superconducting winding with about 15% compared to a static boundary or limit of supplied electrical current.

The chosen safety margin may depend on the particular design of the superconducting rotating electrical machine, superconducting material and operating conditions. As one example of a safety margin may e.g. be about 40%-about 80% of the critical electrical current of a superconductor (as defined previously). In some embodiments, the safety margin may also be of a variable nature, i.e. non-static, and then adjusted according to one or more control objectives.

Optionally, the control system 100 may also control the cooling unit 105.

FIG. 2 schematically illustrates one embodiment of the control scheme of the present invention compared to the traditional situation. Shown are two graphs 210, 211 illustrating a constant electrical current (I_{f,max}=const.) being supplied according to the previously known method and being chosen taking worst case conditions into considerations (i.e. full load and maximum predicted operating magnetic field and temperature) for both I_{q} and I_{d}, respectively, where I_{q} and I_{d} are the parameters obtained after applying the already mentioned Park transformation for the electrical currents and voltages of the rotating and/or stationary winding(s).

Further shown in the two graphs 210, 211 are the electrical current (I_{f,max}=f(I_{d},I_{q})) being dynamically controlled as explained in connection with FIG. 1 and elsewhere.

As readily can be seen, even though the effect is less for I_{d}, in both instances, the dynamic control provides a larger current I_{f} to the superconductive winding for lower values of I_{q} and I_{d}, respectively, thereby increasing the efficiency if the superconductive rotating electrical machine is a generator or motor.

Practically, the relationship between the I_{f,max} value the I_{q} and I_{d} values for a given superconductive rotating electrical machine may be mapped beforehand using an electro-magnetic model of the superconducting rotating electrical machine (as explained in connection with FIG. 1) and stored as a simple look-up table or similar in the control system. Alternatively, I_{f,max} as a function (or approximation thereto) of I_{q} and I_{d} may be stored. Either way, when the I_{q} and I_{d} has been determined during use, it is simple to determine the appropriate I_{f,max} value to use in the control scheme.

In the specific shown example, only the field winding(s) is/are superconductive while the armature winding(s) is/are not and the I_{q} and I_{d} values are obtained using currents and voltages for the armature winding(s) as explained also in connection with FIG. 3.

FIG. 3 schematically illustrates one embodiment of obtaining and deriving control parameters used in one embodiment of the control scheme of the present invention. Shown schematically are a superconductive rotating electrical machine 200 comprising one or more stationary armature windings 103 and one or more rotating field windings 102 and a control system 100 corresponding to the one described e.g. in connection with FIG. 1. The one or more rotating field windings 102 are in this example superconductive while the stationary armature windings are not.

Armature currents and voltages Uₐ, U_{b}, U_{c}, . . . and Iₐ, I_{b}, I_{c}, . . . 301 are supplied to the control system 100. The Park transformation is applied to the received armature currents and voltages providing I_{q} and I_{d} values. Based on these values, the control system then determines the associated I_{f,max} value and supplies this as the field current to the rotating field winding(s) 103.

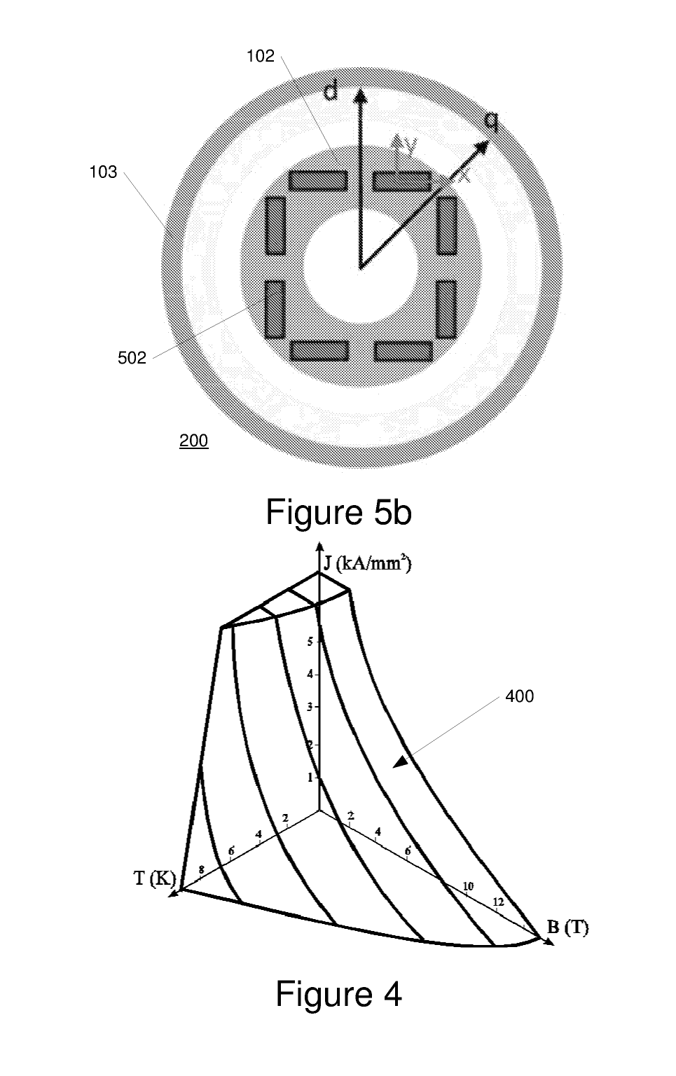

FIG. 4 schematically illustrates an example of superconducting properties for a given superconductive winding. Shown is an area 400 defined according to three parameters T, being the temperature, B being the magnetic flux density, and J being the current density. The indicated area indicates a superconducting region for a given superconductor. Outside this area, no superconducting function is possible and operation could potentially be dangerous at some points for the machine or equipment.

FIGS. 5a and 5b schematically illustrate examples of synchronous superconducting rotating electrical machines with one pair and multiple (e.g. two) pairs of poles that could use the control scheme according to the various embodiments of the present invention.

Shown in FIG. 5a is a superconductive rotating electrical machine 200 comprising at least one stationary winding 103 and at least one rotating winding 102. The superconductive rotating electrical machine 200 comprises in this example one pair of poles 501.

Shown in FIG. 5b is a superconductive rotating electrical machine 200 comprising at least one stationary winding 103 and at least one rotating winding 102. The superconductive rotating electrical machine 200 comprises in this example multiple pairs of poles 502.

In the claims, any reference signs placed between parentheses shall not be constructed as limiting the claim. The word “comprising” does not exclude the presence of elements or steps other than those listed in a claim. The word “a” or “an” preceding an element does not exclude the presence of a plurality of such elements.

The mere fact that certain measures are recited in mutually different dependent claims does not indicate that a combination of these measures cannot be used to advantage.

It will be apparent to a person skilled in the art that the various embodiments of the invention as disclosed and/or elements thereof can be combined without departing from the scope of the invention.

1. A control system for a superconductive rotating electric machine comprising at least one superconductive winding, where the control system is adapted to control a power unit supplying during use the at least one superconductive winding with power or receiving during use power from the at least one superconductive winding, wherein the control system is further adapted to, for at least one superconductive winding, dynamically receive one or more representations of one or more actual values of one or more parameters for a given superconductive winding, each parameter representing a physical condition of the given superconductive winding, and to dynamically derive one or more electrical current values to be maintained in the given superconductive winding by the power unit where the one or more electrical current values is/are derived taking into account the received one or more actual values.

2-14. (canceled)

15. The control system according to claim 1, wherein the control system is adapted to derive the one or more electrical current values as being maximal within a predetermined safety margin for the superconducting rotating electric machine or the at least one superconductive winding while still ensuring that the superconducting rotating electric machine or the at least one superconductive winding is superconductive.

16. The control system according to claim 1, wherein the one or more representations of one or more actual values of one or more parameters comprises:
a current value of an operating temperature of a given superconductive winding,
at least one current value of an electric current of the given superconductive winding, and
at least one current value of a magnetic field of the given superconductive winding.

17. The control system according to claim 16, wherein the current value of the magnetic field of a given superconductive winding is obtained or estimated according to any one of:
using one or more magnetic sensors directly or indirectly measuring or estimating the magnetic field of the at least one superconductive winding,
applying a park transformation on one or more received currents and voltages providing two values (I_{d}; I_{q}), one (I_{d}) being proportional to an armature flux of the superconducting rotating electrical machine of the same orientation as a flux generated by the given superconductive winding and one (I_{q}) being proportional to a torque of the superconducting rotating electrical machine and estimating the magnetic field from two provided values (I_{d}; I_{q}) using an electro-magnetic model of the superconducting rotating electrical machine, or
obtaining the voltage of the given superconductive winding and estimating the magnetic field using the obtained voltage and the current value of an operating temperature and a critical electrical current (I_{c}(B,T)) of the given superconductive winding.

18. The control system according to claim 1, wherein the at least one superconductive winding comprises a superconductive rotating winding and/or a superconductive stationary winding.

19. The control system according to claim 18, wherein the superconductive rotating winding is a superconductive field winding and/or the superconductive stationary winding is a superconductive armature winding.

20. A method of controlling a superconductive rotating electric machine comprising at least one superconductive winding, where the method controls a power unit supplying during use the at least one superconductive winding with power or receiving during use power from the at least one superconductive winding, wherein the method, for at least one superconductive winding, dynamically receives one or more representations of one or more actual values of one or more parameters for a given superconductive winding, each parameter representing a physical condition of the given superconductive winding, and dynamically derives one or more electrical current values to be maintained in the given superconductive winding by the power unit where the one or more electrical current values is/are derived taking into account the received one or more actual values.

21. The method according to claim 20, wherein the method derives the one or more electrical current values as being maximal within a predetermined safety margin for the superconducting rotating electric machine or the at least one superconductive winding while still ensuring that the superconducting rotating electric machine or the at least one superconductive winding is superconductive.

22. The method according to claim 20, wherein the one or more representations of one or more actual values of one or more parameters comprises
a current value of an operating temperature of a given superconductive winding,
at least one current value of an electric current of the given superconductive winding, and
at least one current value of a magnetic field of the given superconductive winding.

23. The method according to claim 22, wherein the current value of the magnetic field of a given superconductive winding is obtained or estimated according to any one of:
using one or more magnetic sensors directly or indirectly measuring or estimating the magnetic field of the at least one superconductive winding,
applying a park transformation on one or more received currents and voltages providing two values (I_{d}; I_{q}), one (I_{d}) being proportional to an armature flux of the superconducting rotating electrical machine of the same orientation as a flux generated by the given superconductive winding and one (I_{q}) being proportional to a torque of the superconducting rotating electrical machine and estimating the magnetic field from two provided values (I_{d}; I_{q}) using an electro-magnetic model of the superconducting rotating electrical machine, or
obtaining the voltage of the given superconductive winding and estimating the magnetic field using the obtained voltage and the current value of an operating temperature and a critical electrical current (I_{c}(B,T)) of the given superconductive winding.

24. The method according to claim 20, wherein the at least one superconductive winding comprises a superconductive rotating winding and/or a superconductive stationary winding.

25. The method according to claim 24, wherein the superconductive rotating winding is a superconductive field winding and/or the superconductive stationary winding is a superconductive armature winding.

26. A superconductive rotating electrical machine comprising at least one superconductive winding, a power unit supplying during use the at least one superconductive winding with power or receiving during use power from the at least one superconductive winding, and a control system according to claim 1.
